(19) United States
(12) Patent Application Publication
(10) Pub. No.: US 2008/0253344 A1
(43) Pub. Date: Oct. 16, 2008

(54) Wireless LAN medium access controller supporting mode change and mode change method therreof

(76) Inventors: Yen-Liang Lin, Mailiao Township (TW); Hsung-Pin Chang, Taichung City (TW); Ruei-Chuan Chang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,216

(22) Filed: Jun. 17, 2008

Related U.S. Application Data
(62) Division of application No. 11/019,221, filed on Dec. 23, 2004.

(30) Foreign Application Priority Data
Oct. 22, 2004 (TW) 93132121

(51) Int. Cl. H04Q 7/24

(52) U.S. Cl. 370/338

(57) ABSTRACT

A wireless LAN medium access controller supporting mode change and the mode change method thereof are proposed. A physical layer detects signal strength in the environment and writes a mode index value of the stronger signal into a register. When the written mode index value is different from a mode index value in the communication system, a medium access controller is informed to perform mode change. The physical layer then sends out an interrupt signal to a central processor and sends the mode index value to the central processor for comparison via a DMA module and a memory. An interface module is used to access the mode index value in the memory for providing an external interface for the medium access control layer. When the mode index value doesn't conform to the signal in the environment, a software layer in the medium access controller is used for mode change.

### RELATED APPLICATIONS

This application is a Divisional patent application of co-pending application Ser. No. 11/019,221, filed on 23 Dec. 2004. The entire disclosure of the prior application Ser. No. 11/019,221, from which an oath or declaration is supplied, is considered a part of the disclosure of the accompanying Divisional application and is hereby incorporated by reference.

### FIELD OF THE INVENTION

The present invention relates to a wireless LAN medium access controller and the mode change method thereof and, more particularly, to a wireless LAN medium access controller supporting mode change and the mode change method thereof.

### BACKGROUND OF THE INVENTION

Recently, wireless communications play an important role in the development of the high-tech industry, among which wireless local area network (LAN) is an even more important technique. Broadband wireless LAN standards have gradually come to maturity. These standards include IEEE 802.11a and HiperLAN type 2 (high performance radio local area network type 2; HiperLAN/2).

The IEEE 802.11a is a standard in the IEEE 802.11 group. The earlier standard in IEEE 802.11 is 802.11, which operates at the band of 2.4 GHz and provides a bandwidth of 2 Mb/s. Next, 802.11b is proposed to provide a bandwidth of 11 Mb/s. This bandwidth, however, isn't enough for use. The standard 802.11a with a higher bandwidth has thus been developed out. The standard 802.111a operates at the band of 5 GHz and can support a bandwidth as high as 54 Mb/s.

The HiperLAN/2 has been proposed to improve the insufficient bandwidth of the HiperLAN/1. The HiperLAN/2 can provide a bandwidth of 54 Mb/s as the IEEE 802.11a.

These two communication systems make use of the modulation technique of orthogonal frequency division multiplexing (OFDM) in the physical layer, and operate at the band of 5 GHz. They differ from each other mainly in the medium access control (MAC) layer.

Because the HiperLAN/2 and IEEE 802.11a have many similar properties in the physical layer, manufacturers have larger flexibility in the development of product, and the cost and the time from research to market can be reduced. Therefore, if an interface simultaneously supporting these two network standards can be provided, it will be great progress in the application of wireless LAN.

A unified communication protocol has been proposed in the disclosure of R.O.C. Pat. No. 548,935 “a communication protocol for coordination of the IEEE 802.11a standard and the ETS-HiperLAN/2 standard” to ensure the coexistence of the IEEE 802.11a and HiperLAN/2 communication systems. This disclosure emphasizes on the coexistence of these two communication systems, but can't switch between them in real time. Moreover, mode change between the PHS and IEEE 802.11b protocols has been proposed in Japan. These two protocols (PHS and IEEE 802.11b) have different MAC layers. Because the way of mode change is accomplished through download of the MAC layer, the process of mode change is very slow.

Accordingly, the present invention aims to propose a wireless LAN medium access controller and the mode change method thereof to solve the above problems in the prior art.

### SUMMARY OF THE INVENTION

An object of the present invention is to provide a wireless LAN medium access controller and the mode change method thereof. The present invention realizes a MAC layer through software. The MAC layer can automatically perform mode change between the two access protocols of the IEEE 802.1a and the HiperLAN/2 to dynamically switch between these two different communication systems, thereby providing the convenience of roaming between two different networks.

Another object of the present invention is to provide a mode change method supporting mode change of wireless LAN. The mode change method detects the magnitude of signal to automatically switch to a corresponding wireless network protocol for providing more stable connection service, lower power consumption, and lower manufacturing cost and difficulty and also speeding up the process of mode change.

To achieve the above objects, the present invention proposes a wireless LAN medium access controller supporting mode change. The wireless LAN medium access controller comprises a software layer and a hardware layer. The software layer comprises a MAC layer and an OS layer under the MAC layer. The MAC layer performs operations of MAC protocol. The OS layer provides an execution environment for the MAC layer. The hardware layer is disposed under the software layer and provides an external interface for the MAC layer and a hardware environment for execution of the software layer.

The present invention also provides a mode change method of a wireless LAN medium access controller supporting mode change. The mode change method comprises the steps of: providing a medium access controller and making use of a physical layer to detect a signal in the environment; determining whether the mode of a communication system conforms to the signal; disabling the medium access controller to keep said mode if the answer is yes, the physical layer writing a mode index value of the signal into a register otherwise; the physical layer sending out an interrupt signal to a central processor in the medium access controller for driving the central processor to execute an interrupt processing function; the central processor reading out the mode index value in the register to determine whether the mode index value in the register and a mode index value existing in the communication system are the same by comparison; leaving the interrupt processing function and keeping the mode if the answer is yes, replacing the mode index value in the communication system with the mode index value in the register otherwise; and using the interrupt processing function to awake a sleeping thread in the central processor for changing the mode of the communication system so as to conform to the signal.

The various objects and advantages of the present invention will be more readily understood from the following detailed description when read in conjunction with the appended drawing, in which:

### BRIEF DESCRIPTION OF THE DRAWINGS

FIG. 1 is an architecture diagram of a medium access controller of the present invention;

FIG. 2 is a circuit block diagram of a hardware layer of the present invention;

FIG. 3 shows storage positions of a software image and a hardware image in a memory of the present invention;

FIG. 4 is a flowchart of mode change of the present invention; and

FIG. 5 is an experimental architecture diagram of two mating hardware layers of the present invention.

### DETAILED DESCRIPTION OF THE PREFERRED EMBODIMENTS

In order to respond to the fast development of today's wireless LAN, it is vital to be able to automatically search a signal and change a mode index value in the communication system so as to conform to the signal in the environment. The present invention proposes a wireless LAN medium access controller and the mode change method thereof, wherein the medium access controller is used for mode change so that the wireless LAN can still be used when the signal in the environment changes.

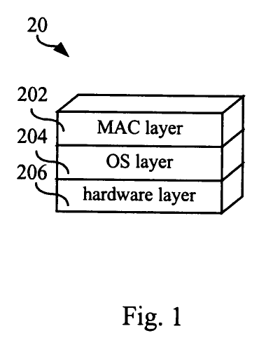

The present invention first proposes a wireless LAN medium access controller supporting mode change. As shown in FIG. 1, a medium access controller 20 comprises a software layer and a hardware layer. The software layer comprises a MAC layer 202 and an OS layer 204 under the MAC layer 202. The medium access controller 20 makes use of the MAC layer 202 to perform operations of MAC protocol. The OS layer 204 provides an execution environment for the MAC layer 202. The hardware layer 206 is disposed under the OS layer 204 and provides an external interface for the MAC layer 202 and a hardware environment for execution of the software layer.

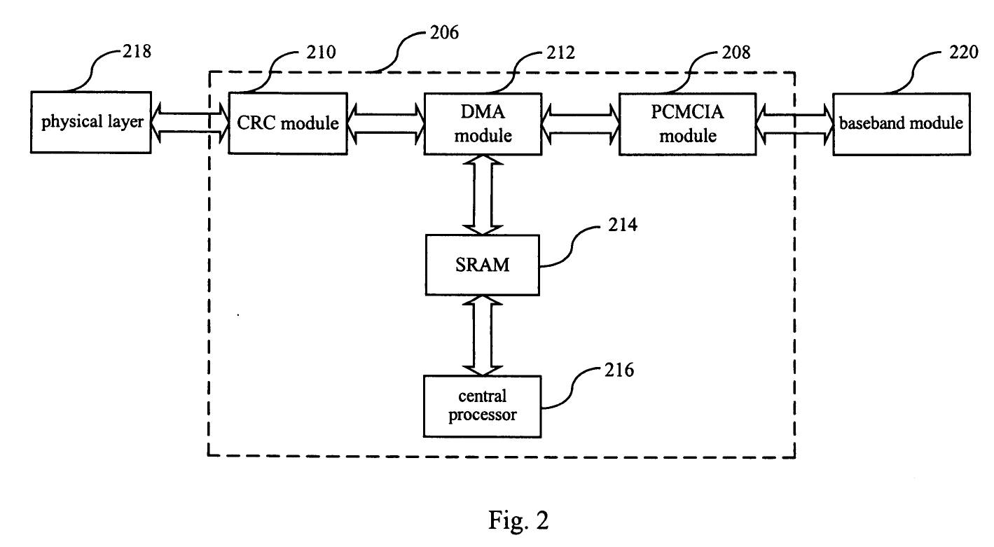

The hardware layer 206 has several different modules. As shown in FIG. 2, the hardware layer 206 comprises an interface module (e.g., a PCMCIA module 208) for communication with a host, a cyclic redundancy check (CRC) module 210, and a direct memory access (DMA) module connected to the PCMCIA module 208 and the CRC module 210 via a 32-bit AMBA bus. These modules are made with Verilog Hardware Description Language design, and are compiled into hardware images. The hardware layer 20 also comprises a memory like an SRAM 214 and a central processor 216. The PCMCIA module 208 provides an external interface for the MAC layer 202. The CRC module 210 is connected to a physical layer 218, detects a signal (e.g., IEEE 802.11a or HiperLAN/2) in the environment to produce a mode index value of the signal, and writes the mode index value into a register (not shown) for sending to the CRC module 210. The DMA module 212 is used to assist the CRC module 210 and the PCMCIA module 208 in speeding up the access of the mode index value in the SRAM 214. The central processor 216 reads out the mode index value in the register for performing mode change.

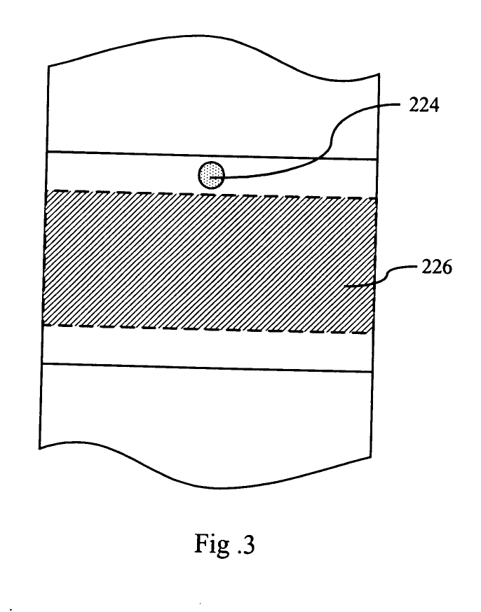

The MAC layer 202 and the OS layer 204 belong to software. As shown in FIG. 3, these two layers will become a software image 224 after compiled and linked. On the other hand, the PCMCIA module 208, the CRC module 210, and the DMA module are all made with Verilog Hardware Description Language design, and are complied into a hardware image 226. The software image 224 and the hardware image 226 are then linked together. The image including the software layer and the hardware layer 206 in linked with software in front of hardware. Next, the whole image is written into a memory. When the software image 224 is executed, it will be copied to some position in the memory. Hardware setting is then performed. That is, the PCMCIA module 208, the CRC module 210, and the DMA module 212 are burned into an FPGA. Subsequently, the setting of the OS layer 204 including the setting of an interrupt processing function is performed. After initialization of the OS is finished, programs of the MAC protocol are executed. In other words, it is necessary to carry out integration of hierarchy and initial setting of system before performing mode change.

The present invention also provides a mode change method of a wireless LAN medium access controller supporting mode change of communication system. Please refer to FIGS. 1 and 2 again. First, a medium access controller 20 is provided. A hardware layer 206 of the medium access controller 20 makes use of a physical layer 218 to detect a signal (e.g., IEEE 802.11a or HiperLAN/2) in the environment. When one of these two signals is stronger, whether the mode in the communication system conforms to the stronger signal is determined. If the mode in the communication system conforms to the stronger signal in the environment, the medium access controller 20 is disabled to keep the mode, otherwise, the physical layer 218 will write a mode index value of the signal into a register in the hardware layer 206 of the medium access controller 20. Next, the physical layer 218 sends out an interrupt signal to a central processor 216, which performs mode change through the software layer. The central processor 216 will execute an interrupt processing function and reads out the mode index value in the register to determine whether the mode index value in the register and a mode index value existing in the communication system are the same. If the mode index values are the same, meaning an invalid notification, the central processor 216 will leave the interrupt processing function, otherwise the mode index value in the communication will be replaced with the mode index value in the register, and the interrupt processing function will be used to wake up a sleeping thread in the central processor 216 for performing mode change of the communication system so as to conform to the stronger signal in the environment, hence accomplishing network roaming in the wireless LAN.

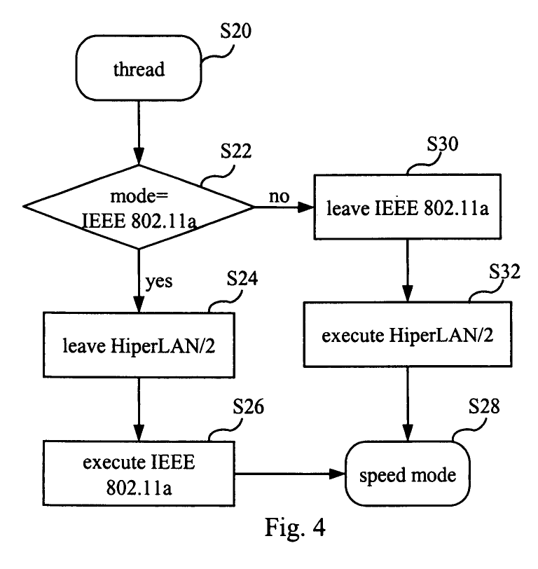

FIG. 4 shows the flowchart of mode change. First, the thread is awaken (Step S20). Whether the mode in the communication system conforms to the IEEE 802.11a standard is determined (Step S22). If the answer is yes, the communication system leaves the HiperLAN/2 mode and the IEEE 802.11a standard is then executed (Step S26); otherwise, the communication system leaves the 802.11a mode and the HiperLAN/2 standard is executed (Step S30). After mode change in Step S26 is finished, the thread enters the sleep state again (Step S28). After Step S30, the mode is changed to the HiperLAN/2 mode (Step S32). After mode change in Step S32 is finished, the thread similarly enters the sleep state (Step S28).

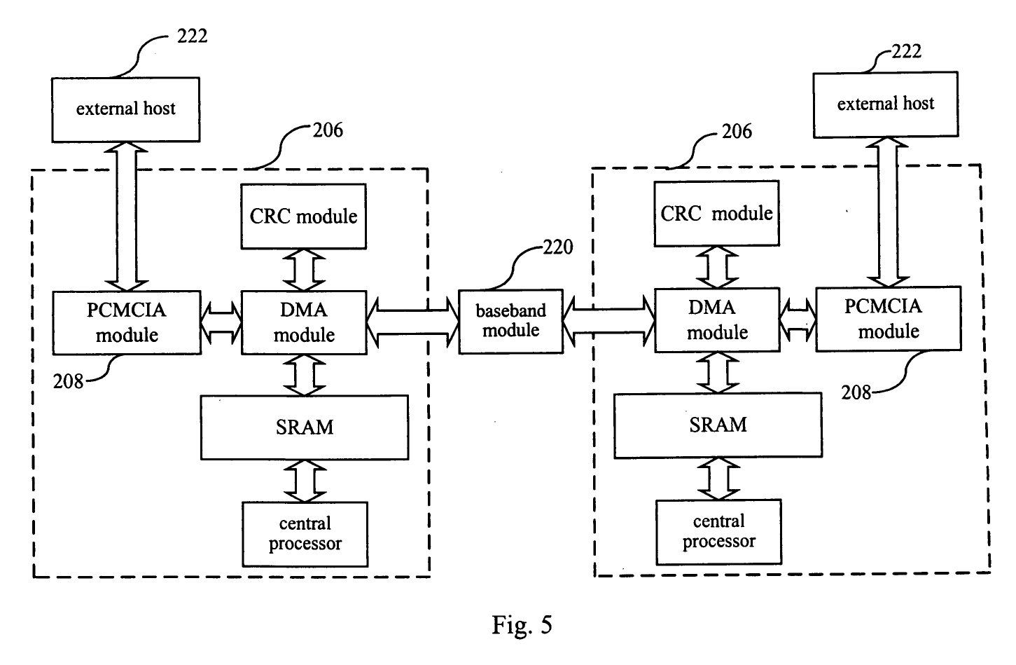

In order to more illustrate the advantages of the present invention, an experiment is made to measure the change time of mode change. FIG. 5 is an experimental architecture diagram of two mating hardware layers 206 of the present invention. Two medium access controllers are provided. A baseband module 220 capable of mating is used to connect the two hardware layers 206 in the two medium access controllers. One of the medium access controllers is used as a fetch point, while the other is used as a mobile device. The two PCMCIA modules 208 in the two hardware layers 206 are connected to two external hosts 222, respectively. The times required for mode change are measured. The time required for mode change from the IEEE 802.11a mode to the HiperLAN/2 mode is measured to be 9.1 ms, while the time required for mode change from the HiperLAN/2 mode to the IEEE 802.11a mode is measured to be 20.4 ms. Therefore, making use of the medium access controller of the present invention for mode change will spend a time not exceeding 21 ms, which is much less than that required for mode change through download of a new protocol.

To sum up, the present invention proposes a medium access controller. When the communication system roams in wireless LAN, the magnitude of signal can be detected, and the medium access controller can be dynamically changed to facilitate continual access to the network for user. The MAC layer is made with software, and can automatically perform mode change between the two access protocols of IEEE 802.11a and HiperLAN/2 to dynamically switch between these two different communication systems. The convenience of roaming between two different networks can be provided for user. A corresponding wireless LAN protocol can be automatically switched to by detecting the magnitude of signal. Therefore, more stable connection service, lower electric power consumption, and lower manufacturing cost and difficulty can be accomplished. Moreover, the time of mode change can the sped up.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A mode change method of a wireless LAN medium access control supporting mode change comprising the steps of: a. providing a medium access controller and making use of a physical layer to detect a signal in the environment; b. determining whether the mode of a communication system conforms to said signal; (b1) disabling said medium access controller to keep said mode if the answer is yes; (b2) said physical layer writing a mode index value of said signal into a register if the answer is no; c. said physical layer sending out an interrupt signal to a central processor in said medium access controller to drive said central processor to execute an interrupt processing function, and said central processor reading out said mode index value in said register to determine whether said mode index value in said register and a mode index value existing in said communication system are the same by comparison; (c1) leaving said interrupt processing function and keeping said mode if the answer is yes; (c2) replacing said mode index value in said communication system with said mode index value in said register if the answer is no; and d. using said interrupt processing function to awake a sleeping thread in said central processor for changing said mode of said communication system so as to conform to said signal.

2. The mode change method of a wireless LAN medium access control supporting mode change as claimed in claim 1, wherein said step of using said interrupt processing function to awake a sleeping thread in said central processor for changing said mode of said communication system so as to conform to said signal further comprises the steps of: detecting and determining whether said mode in said communication system conforms to said signal in the environment; said thread entering the sleep state and keeping the presently used mode if the answer is yes; and said thread performing mode change to change said mode for conforming to said signal and then entering the sleep state after mode change.
